(19) United States
(12) Patent Application Publication
(10) Pub. No.: US 2012/0321925 A1
(43) Pub. Date: Dec. 20, 2012

(54) ENERGY SUPPLY UNIT FOR AN ELECTRICAL DEVICE

(75) Inventor: David Conroy, Brooklyn, NY (US)

(73) Assignee: MARLAFIN AG, Hagendorn (CH)

(21) Appl. No.: 13/579,132

(22) PCT Filed: Dec. 20, 2010
(86) PCT No.: PCT/EP2010/070251

§ 371 Date: Aug. 15, 2012

(30) Foreign Application Priority Data
Feb. 16, 2010 (EP) 10153692.8

(51) Int. Cl. H01M 2/10; B29C 45/00; B29C 45/14

(52) U.S. Cl. 429/99; 264/294; 264/279

(57) ABSTRACT

An energy supply unit (1) for an electrical device comprises a housing (2, 3) having an outer wall and an electrical energy source arranged in the housing (2, 3). A non-reclosable tear-open closure (10, 13) is provided such that the energy source can be removed in order to be disposed of separately but the energy supply unit cannot be equipped with a new energy source.

The invention relates to an energy supply unit for an electrical device, comprising a housing having an outer wall and an electrical energy source arranged in the housing.

Such an energy supply unit is e.g. described in patent application US2007/0260210A1. This reference relates to a vibrating tampon arrangement for relieving menstrual pain. The arrangement comprises a vibration element contained in a tampon and an energy supply unit that is connected to the tampon by a cable and in which an electrical energy source is arranged. The electrical connection between the electrical energy source and the vibration element is controlled by a control unit arranged in the energy supply unit. The control unit allows the vibration element to be operated momentarily for testing purposes. For the intended use, the vibration element is permanently connected to the energy source and this connection cannot be interrupted so that the vibration element vibrates until the energy source is exhausted. The purpose of this operating principle is to ensure that for reasons of user security the tampon arrangement can only be used once. Furthermore, any reuse is prevented by the fact that the energy supply unit is arranged in a closed housing that cannot be opened without being destroyed so that the electrical energy source cannot be replaced.

The disposal of such tampon arrangements is problematic since the usual energy sources contain heavy metals such as mercury. In many countries it is prohibited to dispose of such energy sources e.g. in the household waste. Yet the closed housing makes it impossible to remove the energy source prior to the disposal of the tampon arrangement.

It is an object of the present invention to suggest an energy supply unit for an electrical device that allows removing the electrical energy source contained therein and simultaneously prevents that the energy supply unit may be reused.

According to the invention, this object is attained in that in the outer wall is arranged a non-reclosable tear-open closure for forming an opening for the purpose of removing the electrical energy source.

This solution offers the advantage that the non-reclosable tear-open closure forms an opening through which the energy source can be removed and separately disposed of. However, if a new energy source were to be inserted, this opening cannot be reclosed.

According to one embodiment, the tear-open closure is formed by a weakening line in the outer wall of the housing. This allows a particularly simple manufacture.

According to another embodiment, the housing consists of synthetic material. This measure also allows a particularly simple manufacture, e.g. by injection molding.

According to a further embodiment, the housing is composed of two housing halves. This allows a simple assembly of the energy supply unit.

According to another embodiment, the housing halves are connected to one another by snap elements that are inaccessible from the exterior. In this manner it is prevented that the energy supply unit may be equipped with a fresh energy source by separating and reassembling the housing halves.

According to another embodiment, the tear-open closure is formed by an insert that is inserted in the housing. As compared to a solution using a weakening line, this embodiment provides more freedom in the design of the housing and of the tear-open closure.

If according to a further embodiment the energy supply unit comprises an electrical control element, more particularly a switch, its functionality is extended to that of an energy supply and control unit.

Advantageously, according to a further embodiment, the control unit is arranged underneath a deformable area of the outer wall. In this manner, a tight housing may be provided and the control unit may be actuated by applying pressure to the outer wall. In a particularly advantageous embodiment, the deformable area of the outer wall forms the tear-open closure.

According to another embodiment the tear-open closure is provided with a grip tab. The grip tab can be seized by the fingers in order to remove the tear-open closure.

According to a further advantageous embodiment, a contact element for the electrical energy source is integrated in the tear-open closure. Since this contact element will no longer be in place after tearing open the closure, it is even more difficult to operate the energy supply unit with a newly inserted energy source.

The invention further relates to a method for manufacturing an energy supply unit. The latter is characterized in that one housing portion is produced from a first synthetic material by injection molding while a recess is omitted, and the recess is closed by injecting another synthetic material in order to form an insert.

According to an embodiment variant of the method, simultaneously to the injection of the further synthetic material, the latter is partly injected around a contact element. In this manner, one process step is eliminated in the assembly of the energy supply unit.

Exemplary embodiments of the invention will be explained in more detail hereinafter with reference to the appended drawings showing

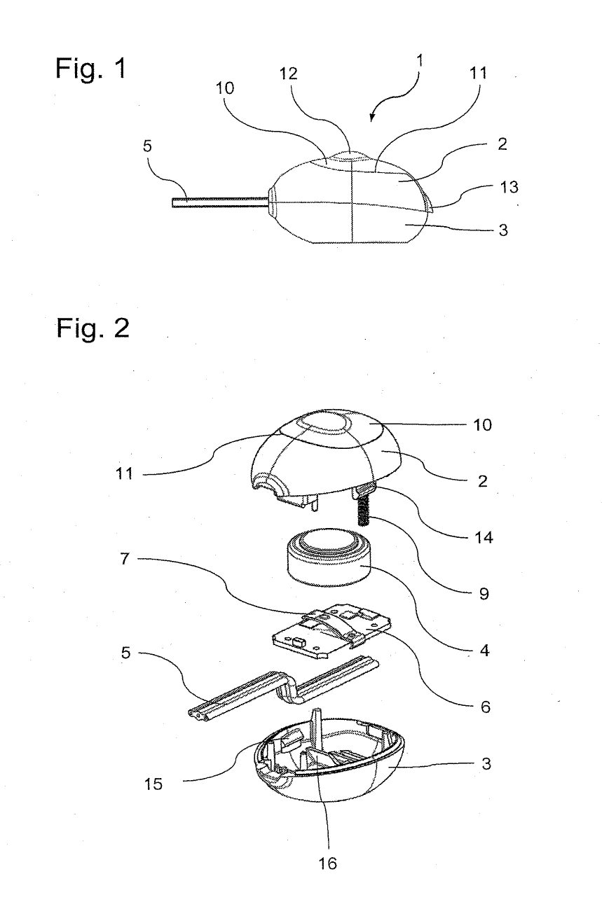

FIG. 1 a side view of the energy supply unit,

FIG. 2 an exploded perspective view of the energy supply unit,

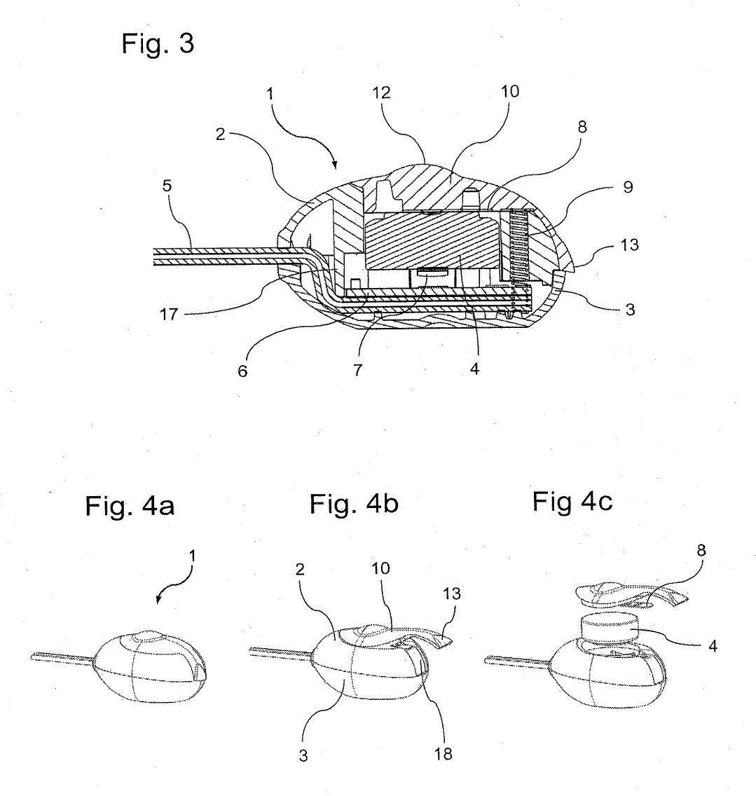

FIG. 3 a sectional view of the energy supply unit at an enlarged scale relative to FIGS. 1 and 2,

FIG. 4a a perspective view of the energy supply unit,

FIG. 4b a view corresponding to FIG. 4a with the tear-open closure partly opened, and

FIG. 4c a view corresponding to FIGS. 4a and 4b with the tear-open closure completely torn off.

FIG. 1 shows a side view of an energy supply unit, designated by reference numeral 1 as a whole, for the supply of an electrical device. The device is not shown in the drawing and is not an object of the invention. Energy supply unit 1 comprises a housing composed of an upper housing part 2 and a lower housing part 3, in which an electrical energy source is arranged that will be described below. A cable 5 connects the energy supply unit to the aforementioned electrical device. In the upper housing part 2, an insert 10 forming a tear-open closure is arranged which is connected to the upper housing part along a separating line 11. Insert 10 has an elevation 12 that projects upwardly in the Figure and whose function will be described below. A grip tab 13 integrally molded with insert 10 allows an easy gripping and tearing off of insert 10.

FIG. 2 shows the energy supply unit in an exploded perspective view. In the depicted example, the electrical energy source is a battery 4, more specifically a so-called button cell of the kind used in small electrical appliances. On top of battery 4, upper housing part 2 with insert 10 and separating line 11 is shown. Below battery 4, a circuit board 6 is visible on which a contact spring 7 is arranged whose function will be described below. Furthermore, circuit board 6 preferably carries electronic circuit elements that are not shown in detail here. Underneath circuit board 6, cutting terminals, also called IDCs (Insulation Displacement Connectors) are arranged which are not visible in the Figure. At the bottom of FIG. 2, the lower housing part is shown with ribs 16 for supporting circuit board 6 formed therein. The function of spring 9 will be explained hereinafter with reference to FIG. 3. In the assembly of the energy supply unit, the individual components are arranged from top to bottom in the order shown in FIG. 2 and then upper housing part 2 is pushed onto lower housing part 3. During this operation, which can be performed without the aid of tools, the cutting terminals connect to cable 5. Finally, latching tabs 14 formed on upper housing part 2 engage in latching tabs 15 provided on lower housing part 3 so that housing parts 2, 3 are connected to one another. Instead of latching tabs, one of housing parts 2, 3 might be provided with recesses in which the latching tabs of the other housing part 3, 2 engage. By a corresponding design of latching tabs 14, 15, particularly of the angles at the mutually engaging portions thereof, it can be excluded that housing parts 2, 3 may be separated from one another without destroying them.

FIG. 3 shows a sectional view of the exemplary embodiment of energy supply unit 1 of the invention at an enlarged scale relative to the previously described Figures. As previously described, insert 10 is arranged in upper housing part 2 so as to adhere along separating line 11 (FIG. 2). In this exemplary embodiment, elevation 12 of insert 10 serves for actuating an integrated switch that works as follows. Battery 4 lies on contact spring 7 and is pushed upwards in the Figure by the latter. On top of battery 4, a contact plate 8 is arranged that contacts the upper pole of battery 4 and conductingly connects it to the circuit arrangement provided on circuit board 6 via spring 9. When a pressure is applied to elevation 12, contact spring 7 yields until it contacts a track arranged on circuit board 6 and thus closes an electric circuit, whereby current is supplied to the electrical device via cable 5. More specifically, the circuit arrangement may be so designed that when a short pressure is applied to the elevation, the power supply is interrupted after relieving the pressure and when a prolonged pressure is applied to elevation 12, the power supply continues after relieving the pressure. Spring 9 also ensures the contact between the circuit board and contact plate 8 when dimensional deviations of the various components are present that may e.g. result from manufacturing tolerances. As it is seen in the drawing, cable 5 is deflected in lower housing part 3 by a rib 17, thereby providing a pullout protection of cable 5.

Housing parts 2 and 3 are advantageously produced from a synthetic material by injection molding. Thus, for example, the upper housing part may be manufactured as a one-piece injection molded part with separating line 11 in the form of a weakening line that surrounds insert 10 intended to be torn off. In the present example, however, insert 10 is made of a different material than the upper housing part, preferably a softer material, and adheres to the material of upper housing part 2. The degree of adhesion may be controlled by the composition of the synthetic materials. The adhesion may be further increased by enlarging the contact surface between parts 2 and 10. Alternatively, one of parts 2 or 10 might have an undercut and thus maintain the other part in its position. However, this would substantially increase the tool costs.

Upper housing part 2 with inset 10 is advantageously produced in an injection molding tool in a stepwise manner. Thus, upper housing part 2 is first injection molded from a first synthetic material. Contact plate 8 has advantageously been placed in the mold beforehand. In a further process step, a second, preferably softer synthetic material is injected which forms insert 10 along with integrally molded grip tab 13, while material is simultaneously injected around contact plate 8 and the latter is embedded in insert 10. Furthermore it is advantageous to ensure that in area 18 (FIG. 4b), where grip tab 13 is in contact with upper housing part 2, no adhesion or at most a very small adhesion exists between these parts 2, 13 in order to facilitate seizing the grip tab. This may e.g. be achieved by applying a release agent.

FIGS. 4a to 4c show the procedure for removing battery 4 in three steps. While the energy supply unit is still completely closed in FIG. 4a, grip tab 13 has already been lifted a little in the illustration of FIG. 4b. In the illustration of FIG. 4c it is seen that insert 10 has been completely separated from upper housing part 2. Then the housing only needs to be turned upside down and battery 4 will fall out. Battery 4 and the other parts may now be disposed of separately.

### LIST OF REFERENCE NUMERALS

1 Energy supply unit
2 Upper housing part
3 Lower housing part
4 Battery
5 Cable
6 Circuit board
7 Contact spring
8 Contact plate
9 Spring
10 Insert
11 Separating line
12 Elevation
13 Grip tab
14 Latching tab
15 Latching tab
16 Rib
17 Rib
18 Area

1. Energy supply unit for an electrical device, comprising a housing having an outer wall and an electrical energy source arranged in the housing, wherein in said outer wall is arranged a non-reclosable tear-open closure for forming an opening for the purpose of removing said electrical energy source.

2. The energy supply unit of claim 1, wherein said tear-open closure is formed by a weakening line in said outer wall of said housing.

3. The energy supply unit of claim 1, wherein said housing consists of synthetic material.

4. The energy supply unit of claim 1, wherein said housing is composed of at least two housing halves.

5. The energy supply unit of claim 4, wherein said housing halves are connected to one another by snap elements that are inaccessible from the exterior.

6. The energy supply unit of claim 1, wherein said tear-open closure is formed by an insert that is inserted in said housing.

7. The energy supply unit of claim 1, wherein it comprises an electric control unit, more particularly a switch.

8. The energy supply unit of claim 7, wherein said control unit is arranged below a deformable area of said outer wall.

9. The energy supply unit of claim 8, wherein said deformable area of said outer wall forms said tear-open closure.

10. The energy supply unit of claim 1, wherein said tear-open closure is provided with a grip tab.

11. The energy supply unit of claim 1, wherein in said tear-open closure a contact element for said electrical energy source is integrated.

12. A method for manufacturing the energy supply unit of claim 4, wherein one of said housing portions is produced from a first synthetic material by injection molding while a recess is omitted, and said recess is closed by injecting another synthetic material in order to form an insert.

13. The method of claim 12, wherein simultaneously to the injection of said further synthetic material the latter is injected around a contact element.
